(19) United States
(12) Patent Application Publication
(10) Pub. No.: US 2008/0203270 A1
(43) Pub. Date: Aug. 28, 2008

(54) Void Former

(75) Inventors: Robert Urquhart Connell, Victoria (AU); Fred Blochlinger, Victoria (AU)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ITW CONSTRUCTION PRODUCTS AUSTRALIA PTY LTD., Oakleigh, Victoria (AU)

(21) Appl. No.: 12/064,862

(22) PCT Filed: Sep. 5, 2006
(86) PCT No.: PCT/IB2006/002441

§ 371 Date: Feb. 26, 2008

(30) Foreign Application Priority Data
Sep. 6, 2005 (AU) 2005904879

(51) Int. Cl. B28B 7/16; B28B 7/28

(52) U.S. Cl. 249/94; 249/175

(57) ABSTRACT

A void former particularly for use with a lifting anchor cast into a concrete component is of two piece construction comprising a flexible element and a separate body which is substantially rigid. The flexible element is engageable with the head of the lifting anchor and is maintained in position by the rigid body which also acts to maintain the shape of the void during casting. After casting the rigid body is removed from the flexible element to thereby permit the flexible element to be disengaged from the lifting anchor by manipulation. The void former is thereby removable after casting without destruction of the void former and is thereby suitable for repeated use.

### BACKGROUND OF THE INVENTION

1. Field of the Invention

The present invention relates to a void former and more particularly to a void former for use with a cast-in lifting anchor for a concrete component.

2. Description of the Prior Art

Cast-in lifting anchors for concrete components such as panels or beams are installed together with the reinforcement prior to casting of the concrete. The anchor has a head designed for co-operation with the lifting equipment such as a lifting clutch. The anchor head carries a removable void former which, when the concrete is cast, forms a recess within an outer surface of the concrete component around the head, so that when the void former is removed the lifting equipment can engage the head within the recess.

One previous form of void former is of moulded plastics and locks onto the head of the anchor by engagement with a lifting eye within the anchor head. This particular form of recess former is designed for a single usage only as it needs to be destroyed to permit its removal from the anchor head after the concrete has set. An alternative form of void former for repeated usage is in the form of a robust rubber moulding consisting of two parts connected together by an integral hinge which permits the two parts to be swung apart and thereby to be disconnected from the anchor head for removal when the concrete has set. While this reusable form of void former is relatively satisfactory, it is quite expensive and on a typical construction site where the components are being cast-on site, a substantial number of these void formers will be required in the production of multiple components with multiple lifting points. As a consequence contractors generally prefer to adopt the significantly cheaper single-use plastic void formers.

### SUMMARY OF THE INVENTION

The present invention seeks to provide a void former capable of repeated use and which can be produced at a cost considerably below that of the reusable rubber void formers previously discussed.

According to the present invention there is provided a void former for application to the head of a cast-in lifting anchor for a cast concrete component, the void former having a relatively rigid body to maintain the shape of the void during casting of the concrete, and a separate locking element of a relatively flexible material to be applied to the anchor head for releasable locking engagement therewith, the rigid body being releasably coupled to the locking element and co-operating with the locking element to maintain it in locking engagement with the anchor head whereby removal of the void former from the void after setting of the concrete can be accomplished by withdrawing the body from engagement with the locking element and then releasing the flexible locking element from its locking engagement with the anchor head.

In one preferred form, the locking element consists of an outer shell of a flexible manipulable material, polyurethane being preferred. The shell defines the shape of the void, and the shape of the shell and thereby of the void is maintained by the relatively rigid body which is in the form of an insert placed within the interior of the shell when the shell has been coupled to the anchor head. In this form of the invention, it is the shell that is in contact with the wet concrete during casting. For a lifting anchor of the type in which the head includes a lifting eye, the shell has at least one, and preferably a pair of, locking lugs which engage within the eye and the rigid insert when within the shell maintains the lugs in engagement within the eye.

In an alternative form, the relatively rigid body defines the shape of the void by being in contact with the wet concrete during casting, the locking element of flexible material being fitted to the anchor head for locking engagement therewith and the relatively rigid body being fitted over the locking element and being releasably retained thereto. As with the first form of the invention, the locking element may be of polyurethane, and for use with a lifting anchor of the type discussed above has at least one, and preferably a pair of, locking lugs which engage within the eye of the anchor, and the relatively rigid body when applied to the locking element co-operates with the element to retain the locking lug(s) in engagement within the eye.

In each embodiment the relatively rigid body is releasable from the locking element by movement away from the anchor head in the direction of the axis of the head thereby exposing the locking element within the void to permit its release from the anchor head in a manner which will not result in destruction of the locking element. The necessary movement of the relatively rigid body can arise as a result of removal of associated formwork to which the body is attached.

The ease with which the locking element can be released from engagement with the anchor head after removal of the relatively rigid body means that the locking element and the body itself can be repeatedly reused.

The relatively rigid body is preferably of one-piece plastic construction, for example of nylon or polypropylene. It can be injection moulded as a relatively thin-walled body with internal reinforcing walls or webs to provide the necessary structural rigidity.

A void former in accordance with the broad principles of the invention is also suitable for use with other fittings which can be cast into a concrete component to provide an anchoring point within the component.

Accordingly, another aspect of the invention provides a void former for forming a void in the surface of a cast concrete component to provide access to an anchoring fitting incorporated into the component during the casting thereof, the void former comprising a flexible shell in the shape of the void to be formed, the shell being engageable with an outer end portion of the fitting, and a substantially rigid insert engageable into the shell to preserve its shape during casting, the insert being removable from the shell after casting to permit the shell then to be removed from the void by manipulation as a result of its flexibility to thereby expose the outer end portion of the fitting for access via the void.

Yet another aspect of the invention provides a void former for forming a void in the surface of a cast concrete component to provide access to an anchoring fitting incorporated into the component during the casting thereof, the void former comprising a substantially rigid body defining the shape of a void to be formed, and an element of flexible material engageable with an outer end portion of the fitting, the rigid body co-operating with the flexible element to retain it in engagement with the fitting whereby after formation of the void, the rigid body is removable from the flexible element to permit the flexible element then to be removed from the fitting by manipulation of the flexible element to thereby expose the outer end portion of the fitting for access via the void.

### BRIEF DESCRIPTION OF THE DRAWINGS

Embodiments of the invention will now be described by way of example only with reference to the accompanying drawings in which:

FIG. 1 is an exploded view of a void former in accordance with a first embodiment of the invention;

FIG. 2 shows the void former of FIG. 1 applied to the head of a lifting anchor;

FIG. 3 is a view looking at the underside of the void former when applied to the anchor;

FIG. 4 is a section on line A-A of FIG. 3;

FIG. 5 is a section on line B-B of FIG. 3;

FIG. 6 is an exploded view of a second embodiment of a void former in accordance with the invention;

FIG. 7 shows a locking insert of the void former of FIG. 6 in a flattened form;

FIG. 8 is a perspective view showing the void former of FIG. 6 applied to the head of a lifting anchor;

FIG. 9 is a view looking at the underside of the void former of FIG. 6 when applied to the anchor;

FIG. 10 is a section on line A-A of FIG. 9; and

FIG. 11 is a section on line B-B of FIG. 9.

### DESCRIPTION OF THE PREFERRED EMBODIMENTS

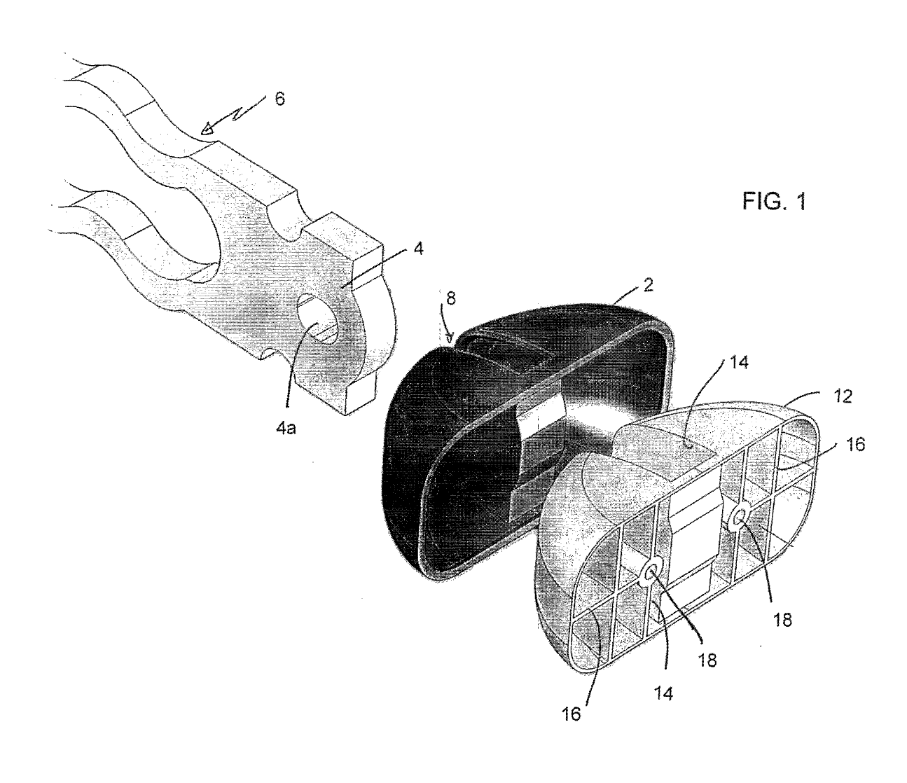

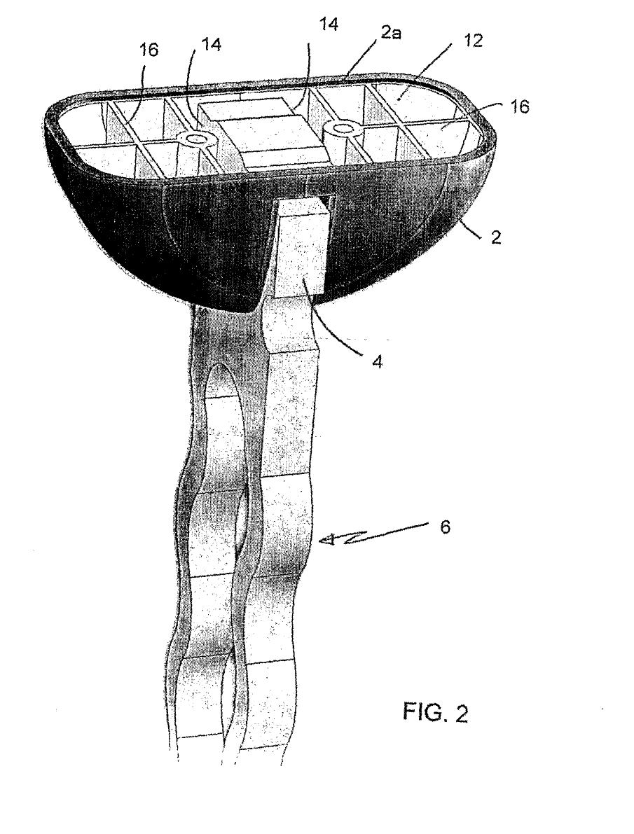

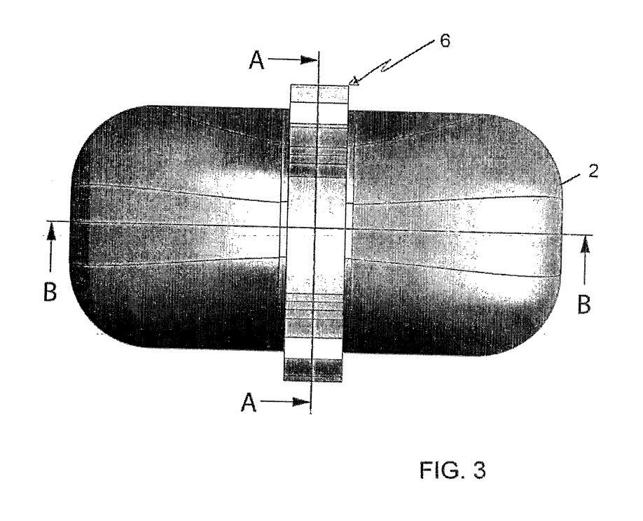

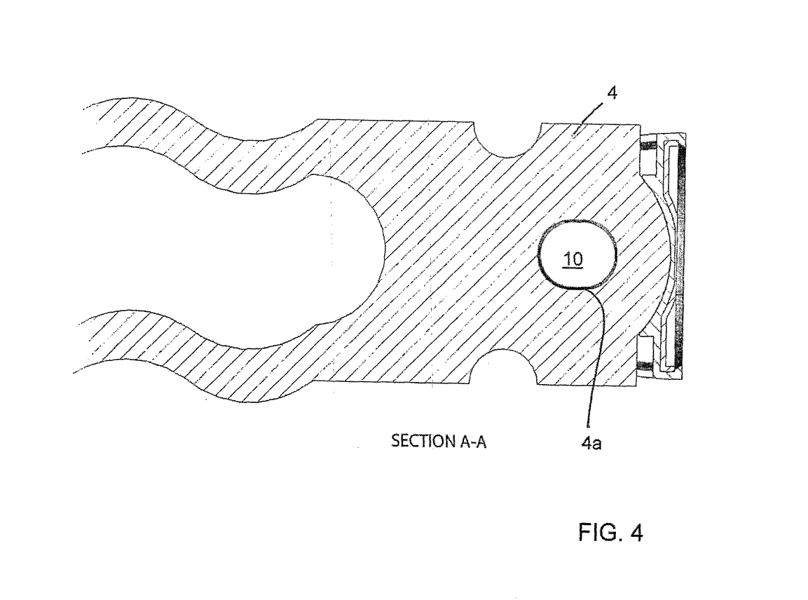

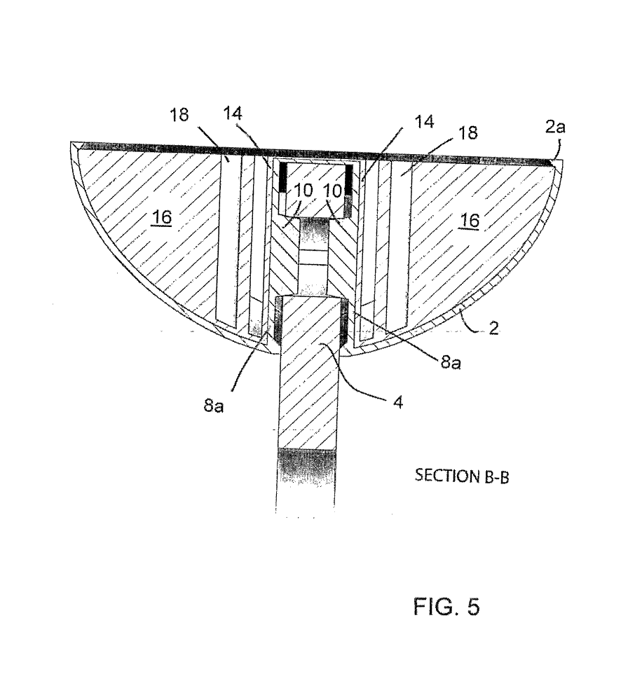

With reference to FIGS. 1 to 5 the void former in accordance with a first embodiment of the invention comprises an outer shell 2 moulded in a flexible hard-wearing plastics, for example a flexible polyurethane. The shell 2 fits over the head 4 of the anchor 6 and defines the shape of the void to be formed during casting of the surrounding concrete. The anchor head 4 fits into a recess 8 which opens onto the external surface of the shell 2 and which includes in its opposite side walls 8a (see FIG. 5) integral lugs 10 which engage into the lifting eye 4a in the head 4 of the anchor. The shell 2 thereby constitutes a locking by which the void former is locked to the anchor head, specifically as a result of the engagement of the lugs 10 within the eye 4a.

The flexibility of the shell 2 which is such as to enable the shell 2 to be manipulated for release from the anchor head 4 when the concrete has set, means that it will have insufficient inherent structural rigidity to resist deformation by the concrete during casting. Accordingly, the interior of the shell 2 is designed to receive a separate reinforcing structure provided by a one-piece insert 12 which provides the necessary rigidity during casting. As shown, the insert 12 has a complimentary shape to that of the interior of the shell 2 and is a push fit within the interior of the shell 2 to aid its retention. Internal walls 14 of the insert 12 lie at the outer sides of the walls 8a defining the recess 8 to prevent deformation of those walls and thereby disengagement of the lugs 10 from the anchor head 4 when the insert 12 is in place within the shell 2. The insert 12 is of a lightweight-thin walled structure injection moulded in a one-piece suitable plastics such as nylon or polypropylene. The insert 12 includes internal webs 16 to provide the necessary rigidity. The interior of the insert 12 also includes tubular passages 18 opening onto the face of the insert for receiving self-tapping screws to attach the void former to adjacent formwork.

The insert 12 is applied to the interior of the shell 2 after the shell 2 has been attached to the anchor head 4 and the insert 12 is positively retained in position within the shell 2 by snap-in engagement beneath an overhanging lip 2a extending around the open face of the shell 2.

To remove the void former from the anchor head 4 after the concrete has set, the insert 12 is removed from the interior of the outer shell 2 by pulling the insert 12 away from the anchor head generally in the direction of the axis of the anchor; when, as is usually the case, the recess former has been attached to formwork, removal of the formwork from the cast component will also result in removal of the insert 12 to which it is attached. The outer shell 2 can then by manipulated sufficiently within the void to disengage its lugs 10 from the anchor eye 4a to thereby permit the entire shell 2 to be removed. The insert 12 can then be detached from the formwork and the void former is then in a condition for re-use.

The void former shown in FIGS. 1 to 5 is designed for attachment to formwork and therefore it is not necessary for the outer side of the insert to be closed as concrete is unable to enter into the insert via the open face when that face is tightly abutting the adjacent face of the formwork. However, a void former of the type described can also be adapted for use in a situation in which it lies at an exposed face of the component being cast, for example as may arise in a tilt-up face lift situation for a concrete panel. In that case, the open face of the insert can be closed by a cover plate (not shown) either permanently secured to the insert for example by means of an adhesive or having an integral locking connection with the insert. It will of course be understood that even if the insert is supplied with a cover plate, the presence of the plate will not interfere with the attachment of the insert to formwork.

In this embodiment the interface between the void former and the wet concrete is provided solely by the outer shell which is tightly engaged with the anchor head by the action of the insert and as a result wet concrete is unlikely to penetrate between the shell and the anchor head. Moreover the outer shell is completely closed at its interface with the concrete and at its interface with the anchor head so that wet concrete cannot penetrate into the interior of the shell.

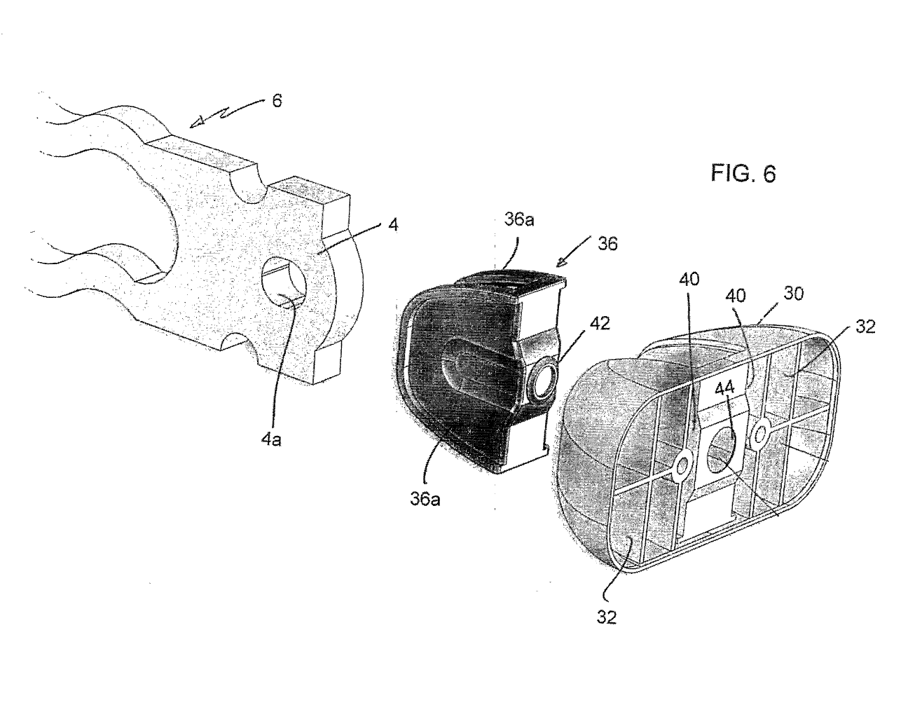

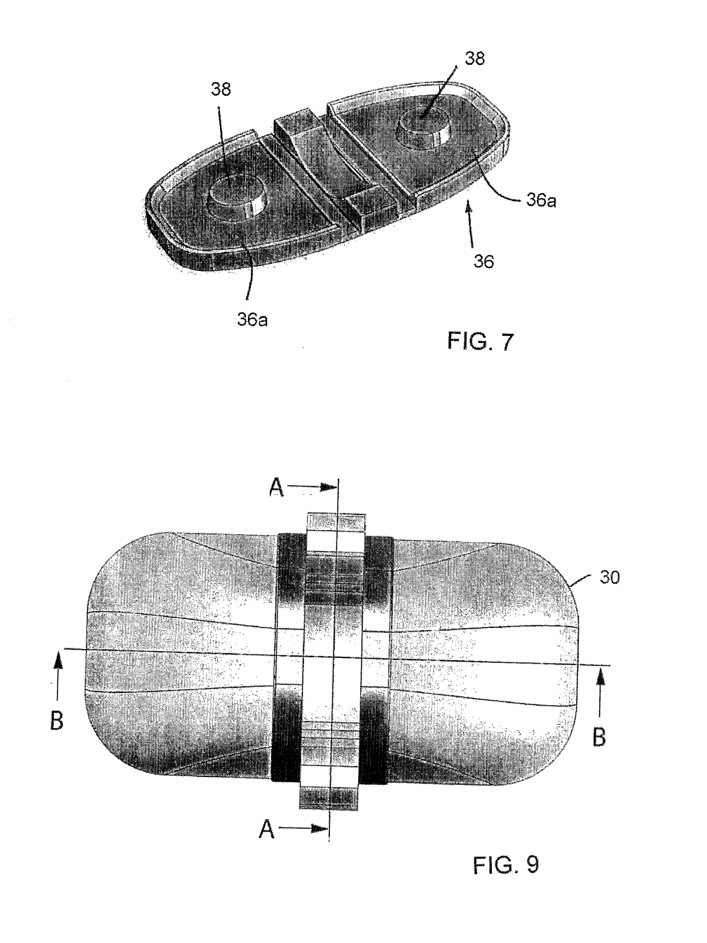

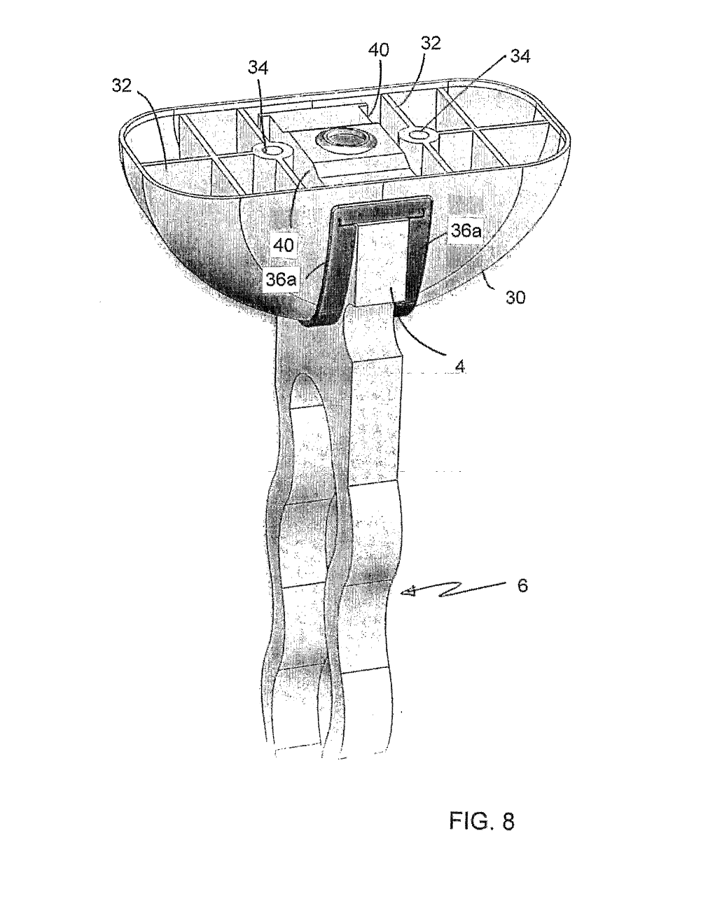

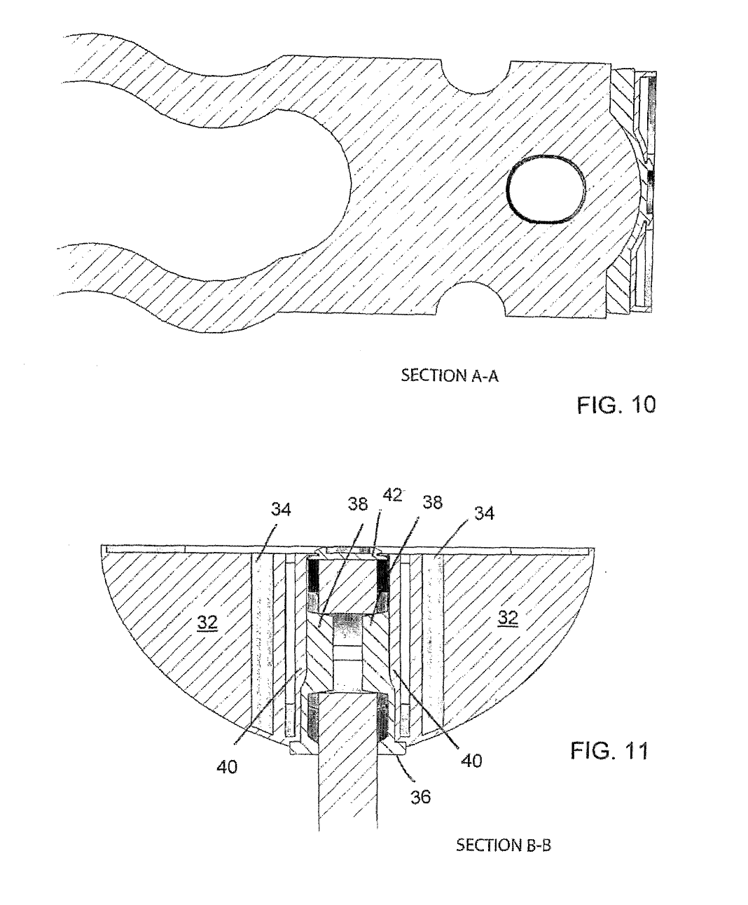

In an alternative embodiment shown in FIGS. 6 to 11, the main body 30 of the void former is formed from a thin-walled relatively rigid moulded plastics component of similar structure to the insert 2 of the previous embodiment. Similarly, it can be formed in nylon or polypropylene for example, and includes internal reinforcing webs 32 and passages 34 for self-tapping screws by which the body can be attached to formwork. The body 30 is associated with a separate locking insert 36 formed of a flexible material, polyurethane being preferred. The locking insert 36 is of a generally flat form (see FIG. 7) with lugs 38 projecting from sides 36a, and the insert 36 can be applied to the head 4 of the anchor by being folded into a generally U-shape (as shown in FIG. 6) so that the lugs 38 engage into the eye 4a of the anchor head 4. With the locking insert 36 applied to the anchor head 4, the main body 30 of the void former is applied over the insert 36, with internal walls 40 of the body 30 lying to the outside of the sides 36a of the folded insert to retain the lugs 38 in engagement with the anchor head 4. A resilient locking collar 42 extending outwardly from the central portion of the folded insert 36 releasably locks over a locking aperture 44 formed in a wall of the main body 30 in order to releasably retain the body 30 to the locking insert 36.

Similarly to the first embodiment, the open face of the body 30 can be closed by a cover plate (not shown) to prevent ingress of concrete into the interior in a situation where the void former is applied to an exposed face of the component.

In order to remove the void former when the concrete is set, the main body 30 is pulled axially away from the locking insert 36 typically as a result of removal of the formwork to which the body 30 is attached, thereby releasing the engagement with the locking collar 40 whereby the body 30 can be completely removed. The insert 36 is accordingly exposed and can be released from the anchor head 4 by swinging its opposite sides 36a outwardly to disengage the lugs 38 from the anchor eye 4a.

Although this second embodiment provides a practical alternative to the first, nevertheless it does provide a greater number of interfaces which are exposed to the presence of wet concrete and which might in some circumstances be subject to penetration by the wet concrete. Accordingly the first of the two embodiments is preferred.

Although the preferred embodiments have been described with reference to a void former configured for coupling with an anchor head of the type which has an eye for co-operation with a locking bolt of a lifting clutch, the broad principles of the invention described herein can readily be applied to void formers for use with other designs of anchor head.

The embodiments have been described by way of example only and modifications are possible within the scope of the invention.

1. A void former for application to the head of a cast-in lifting anchor for a cast concrete component, the void former having a relatively rigid body to maintain the shape of the void during casting of the concrete, and a separate locking element of a relatively flexible material to be applied to the anchor head for releasable locking engagement therewith, the rigid body being releasably coupled to the locking element and co-operating with the locking element to maintain it in locking engagement with the anchor head whereby removal of the void former from the void after setting of the concrete can be accomplished by withdrawing the body from engagement with the locking element and then releasing the flexible locking element from its locking engagement with the anchor head.

2. A void former according to claim 1, wherein the locking element consists of an outer shell of a flexible manipulable material.

3. A void former according to claim 2, wherein the shell defines the shape of the void to be formed, and the shape of the shell and thereby of the void is maintained by the relatively rigid body which is in the form of an insert placed within the interior of the shell when the shell has been coupled to the anchor head.

4. A void former according to claim 3 for use with a lifting anchor of the type in which the head includes a lifting eye, wherein the shell has at least one locking lug which engages within the eye and the rigid insert when within the shell maintains the lug in engagement within the eye.

5. A void former according to claim 1, wherein the relatively rigid body defines the shape of the void by being in contact with the wet concrete during casting, the locking element of flexible material is fitted to the anchor head for locking engagement therewith, and the relatively rigid body is fitted over the locking element and is releasably retained thereto.

6. A void former according to claim 5 for use with a lifting anchor of the type in which the head includes a lifting eye, wherein the locking element has at least one locking lug which engages within the eye of the anchor, and the relatively rigid body when applied to the locking element co-operates with the element to retain the locking lug in engagement within the eye.

7. A void former according to claim 1, wherein the relatively rigid body is releasable from the locking element by movement away from the anchor head in the direction of the axis of the head thereby exposing the locking element within the void to permit its release from the anchor head in a manner which will not result in destruction of the locking element.

8. A void former for forming a void in the surface of a cast concrete component to provide access to an anchoring fitting incorporated into the component during the casting thereof, the void former comprising a flexible shell in the shape of the void to be formed, the shell being engageable with an outer end portion of the fitting, and a substantially rigid insert engageable into the shell to preserve its shape during casting, the insert being removable from the shell after casting to permit the shell then to be removed from the void by manipulation as a result of its flexibility to thereby expose the outer end portion of the fitting for access via the void.

9. A void former for forming a void in the surface of a cast concrete component to provide access to an anchoring fitting incorporated into the component during the casting thereof, the void former comprising a substantially rigid body defining the shape of a void to be formed, and an element of flexible material engageable with an outer end portion of the fitting, the rigid body co-operating with the flexible element to retain it in engagement with the fitting whereby after casting, the rigid body is removable from the flexible element to permit the flexible element then to be removed from the fitting by manipulation of the flexible element to thereby expose the outer end portion of the fitting for access via the void.

10. A void former for use with a lifting anchor cast into a concrete component, the void former being of two piece construction and comprising a flexible element and a separate body which is substantially rigid, the flexible element being engageable with the head of the lifting anchor and being maintained in position by the rigid body which also acts to maintain the shape of the void during casting, the rigid element being removable from the flexible element after casting to thereby permit the flexible element to be disengaged from the lifting anchor by manipulation, whereby the void former is removable after casting without destruction of the void former and is thereby suitable for repeated use.
